(19) United States
(12) Patent Application Publication
(10) Pub. No.: US 2007/0266337 A1
(43) Pub. Date: Nov. 15, 2007

(54) Contextual link display in a user interface

(76) Inventors: Liam Friedland, Redwood City, CA (US); Peer Hilgers, St. Leon-Rot (DE)

Correspondence Address: KENYON & KENYON LLP, ONE BROADWAY, NEW YORK, NY, 10004, US

(21) Appl. No.: 11/435,103

(22) Filed: May 15, 2006

(51) Int. Cl. G06F 9/00

(52) U.S. Cl. 715/805

(57) ABSTRACT

A user interface includes multiple operating domain identifiers, each identifying an operating domain. These domain identifiers are readily displayed on the interface. The interface further includes an indicator indicating a selected operating domain from one of the operating domains visibly displayed in the interface. The interface further includes a primary display having a session of an application associated with the selected operating domain executing therein. The interface further includes a second display having a plurality of links, each of the links being contextually related to the selected operating domain. Thus, the interface provides the central display of the application, the operating domain of the application and contextually related links associated therewith.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to an interface and more specifically to an interface and the underlying processing techniques for managing multiple sessions of one or more software applications through a central interface.

In a processing environment, the user is typically presented with a display of an activated application. This application may be locally or remotely processed and may include access to local or remote data storage locations. From the user's perspective, this application is actively displayed in a window or other type of display environment.

In it is not uncommon for the application to have related applications or functions not directly accessible through the current display. For example, if the application is directed to a first function, the user may concurrently wish to perform a second or third function that requires either another application or a different level in the application. In existing interfaces, the user is required to navigate to this second or third function from a base entry point of the normal interface. For example, if the user requires launching the second application, the user must return to a central interface and select the second application. Using the example of the third function being a sub-level, the user must navigate through normal sub-menu commands or other interfunctionality to get to various levels.

Existing system interfaces provide accessibility to different applications or functions, grouped together, such as accessible in a central folder or toolbar. For example, in a Windows computing environment, a user may group similar applications in a start menu, sub-menu option or desktop folder. This can provide a convenient location for activation commands to launch the applications and allow the user to perform related functions.

Although, these existing techniques fail to provide functionality underlying the grouping. For example, a convenient disposition of links in a folder still requires the user to launch the applications from the decentralization location. Additionally, this technique does not allow a user to activate sub-level functions in existing applications, but would rather only allow a user to enter designated applications from a standard entry point.

In existing interfaces with applications, there may be recommended functions through pull down menus or other operations. For example, some applications include functions associated with highlighted text. In a word processing application, you may highlight or otherwise designate text and using a predefined input function to launch associated activities, such as a spell checker or a thesaurus. These functions may also be available from pull down menus or visual icons displayed on a toolbar or other location.

Although, these functions are limited to the pre-existing functionality associated with the application itself. Additionally, these functions are embedded not in the user interface, but rather within the application itself. There does not exist functionality in the interface running the application, therefore this functionality does not provide for launching related applications that may be used concurrently.

There is also a distinction between various levels of interfaces, including the commonly utilized desktop interface, but also the application-specific interface. While the desktop interface provides the general framework for an operating system, the application-specific interface provides the internal interactivity for using the application. There are also interfaces that merge these two concepts by providing access to an application through the interface itself. In these applications, the interface provides the portal to back-end accessibility, where an application or other type of computing session may be processed in a different application and the interface provides the user the ability to view the data interchange.

This interface includes the additional benefits of launching numerous related applications from the single portal. For example, an Internet browser might allow a user to launch different applications within the same interface, such as music player and a video player. Although, these interfaces do not have the links to associated functions. The interface may include standard selection options, but these are generalized selectable options without contextual reference to current operating features being currently performed in the interface.

### BRIEF DESCRIPTION OF THE DRAWINGS

FIG. 1 illustrates a processing environment having a user interface in accordance with one embodiment of the present invention;

FIG. 2 illustrates a block diagram of one embodiment of a processing system operative to provide the user interface in accordance with one embodiment of the present invention;

FIG. 3 illustrates a sample screen shoot of an interface in accordance with one embodiment of the present invention;

FIG. 4 illustrates a schematic diagram of one embodiment of an apparatus for providing a visual display of contextually related links in the interface; and

FIG. 5 illustrates a flowchart of the steps of one embodiment of a method for a user interface display.

### DETAILED DESCRIPTION

In a user interface, the content and position of information provides improvements in user efficiency and ease of operation. In an interface system providing a portal to an application, the interface may be able to provide directed links and other information associated with the application. As the interface may provide accessibility to different types of applications, described herein as different operating domains, the interface further provides directed links to the associated operating domain. Therefore, the interface provides a readily available directed access to associated applications or functions, related to the underlying application being executed in the interface and associated with the type of operations being performed.

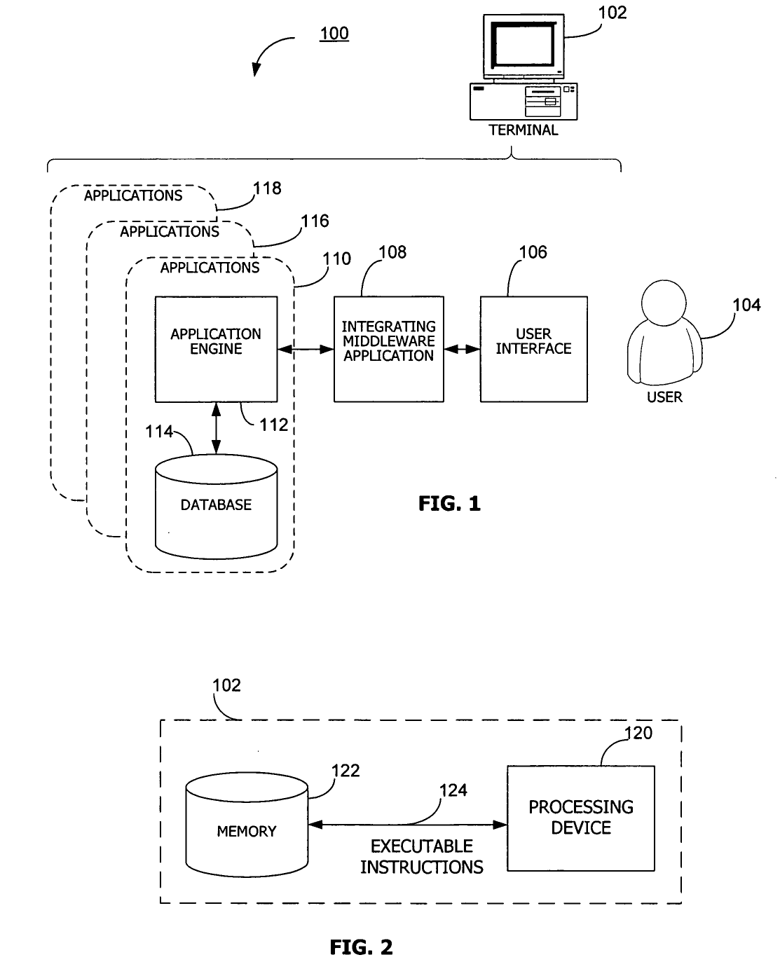

FIG. 1 illustrates a system 100 for providing a transaction browser that includes an interface according to an embodiment of the present invention. A terminal 102 may be available to a user 104. The terminal 102 may include an output device such as a display screen and an input device such as a keyboard or a mouse. For example, the terminal 102 may be a personal computer, a laptop computer, a tablet computer, a personal digital assistant (PDA) or a wireless device such as a cell phone.

The terminal 102 may include a processor configured to execute various application programs such as browser programs, word processing programs, spreadsheet programs, enterprise management applications and other applications. For example, the terminal 102 may execute a user interface 106. For example, the user interface 106 may be implemented as a shell program.

The user interface 106 may be in communication with an integrating middleware application 108. The middleware application 108 may interface between the user interface 106 and applications 110. Applications 110 may include an application engine 112 and a database 114. More than one application engine may be provided, but only one is depicted. For example, each application engine may execute a plurality of applications.

The application engine 112 may execute different applications, such as a calendar software, a contacts management software, a customer data entry form, sales order creation form, or other applications. The database 114 may include data relevant to the applications offered on the terminal 102. Data may include information for each transaction or report available through the applications 110. Data may also include business logic defining available actions in applications 110.

The terminal 102 may include a plurality of applications. For example, Applications 116 and 118 may also execute on the terminal 102. Each of Applications 116 and 118 may be similar to Applications 110, including an application engine and a database.

The terminal 102 may include a network interface configured to communicate with a server. For example, the applications 110 may be located at the server. In this example embodiment, the middleware application 108 may communicate with the applications 110, 116 and/or 118 via the network interface.

FIG. 2 illustrates a representative embodiment of hardware components within the terminal 102, including a processing device 120 and a memory 122. The processing device 120 may be one or more processing elements operative to perform processing operations in response to executable instructions 124 stored in and received from the memory 122. The memory 122 may be one or more memory devices capable of storing the executable instructions for retrieval and usage by the processing device 120. The processing device 120, in response to the executable instructions 124 is operative to provide the interface 106 and perform various operations as described in further detail below.

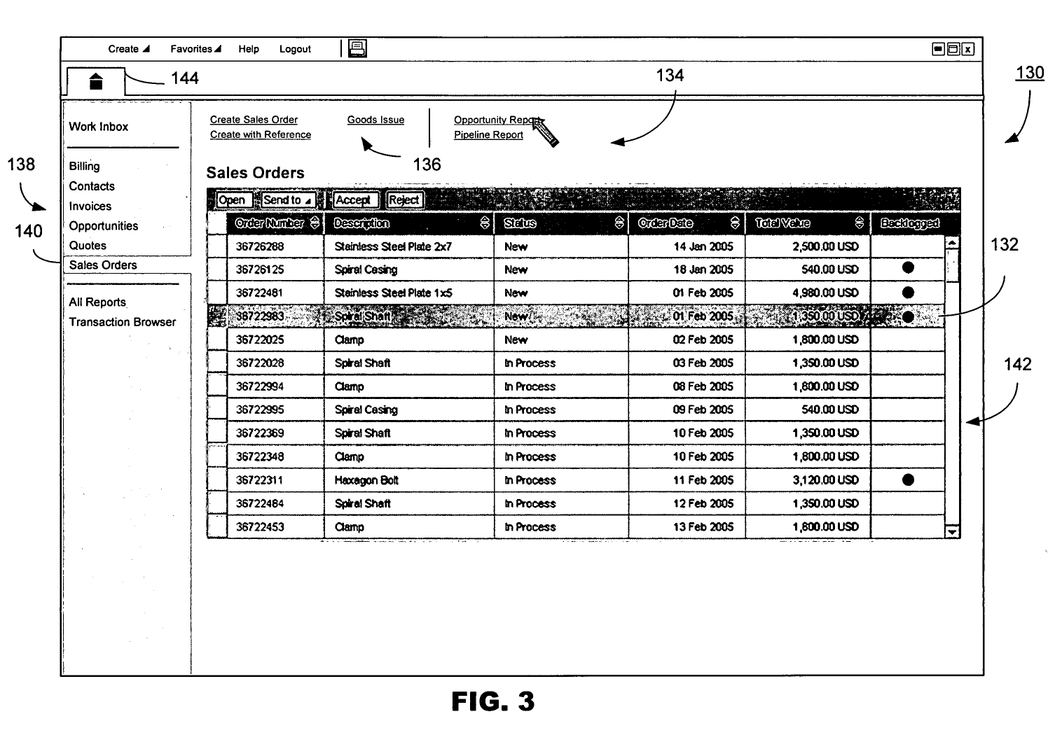

FIG. 3 illustrates a screen shot 130 of one embodiment of the interface 106 of FIG. 1. As described above relative to FIG. 1, the interface 106 may utilize integrating middleware application 108 to access one or more applications 110, 116 or 118. The interface 106 provides the visual display of the primary display 132 having a computing session of an application executing therein. In this example, the application is a sales order application including a plurality of sales order data fields.

Also visible in the screen shot 130 is a secondary display 134 having a plurality of links 136. These links 136 are to launch related applications or functions associated with the application in the primary display. The screen shot 130 further illustrates a display of operating domains 138, which are various type of operational fields through which the interface may provide applications. Each operating domain 138 relates to a different field of use and therefore there may be different applications, available through the interface 106. For example, the screen shot 130 illustrates the representative domains of Billing, Contacts, Invoices, Opportunities, Quotes and Sales Orders. Upon selection of the Billing domain selector, the primary display 132 may display a billing application, for example.

In screen shot 130, the interface 106 further provides an indicator 140 that indicates selected operating domain. This indicator 140 can provide the user a visual confirmation of the operating domain with which the application in the primary display relates. Additionally, the interface 106 displays the links 136 in the secondary display 134 that are contextually related to the selected operating domain 138. Therefore, in the interface 106, pre-existing links to contextually related activities are provided in a foreground display. A user interacting with the interface has these contextually related links readily accessible without adversely affecting the utilization of the application in the primary display 132.

In additional functionality, the links 136 may relate to one or more elements 142 within the application. In the screen shot 130, the element 142 is highlighted to designate its selection. The links 136 may relate to functionalities or sessions associated with the element 142. Therefore, the interface further allows the launching of a directed activity through the selection of an element 142 and an link 136.

The interface 106 further includes the ability to display multiple sessions or displays in a tabbed format. In the screen shot, a first tab 144 is visible. Upon selection of a link 136 and the launch of an application, a new tab display may be generated including the primary display and associated links in a secondary display. To maintain a visual interface, a second tab may be generated next to the first tab 144. In the event the newly launched activity receives a foreground display over the primary display 132 in the screen shot 130, the first tab 144 may be the only visible component, allowing a user to switch between screens using tabbed interface functionality.

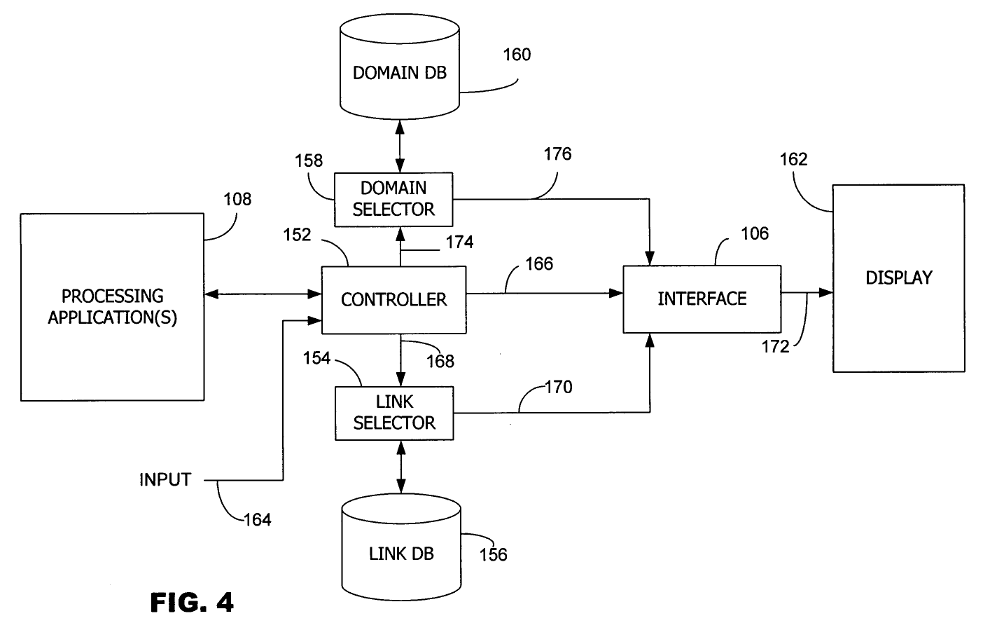

FIG. 4 illustrates an apparatus 150 providing a user interface display. The apparatus 150 includes processing application(s) 108 (which may also be 116 and/or 118), a controller 152, interface 106, link selector 154, an link database 156, a domain selector 158, a domain identifier database 160 and a display 162.

The controller 152, interface 106 and selectors 154, 158 may be hardware, software or a combination thereof. These components provide for associated functionality as described herein. The database 156 and 160 may be one or more storage devices having information stored therein. The display device 162 may a display associated with the terminal 102 of FIG. 1.

In one embodiment, the controller 152 receives an input command 164 directed to launching an application 110 in the interface 106. The controller 152 launches the application 108 providing primary display data 166 to the interface 106. Additionally, based on the selected application 106, the controller 152 provides the link selector domain selection data 168 which indicates an operating domain associated with the application. Using the screen shot of FIG. 3, the domain selection data 168 may indicate the operating domain of a sales order.

In response to this data 168, the link selector 154 may thereupon access the link database 156 having a plurality of links stored therein. The link selector 154 retrieves links based on the domain selection data 168, where the retrieved links are associated with the operating domain. The selector 154 thereupon provides a plurality of these links 170 to the interface. The interface 106 thereupon includes these links 170 in the secondary display, such as illustrated in FIG. 3.

The interface 106 thereupon provides a display signal 172 to the display 162 for subsequent display. Through an input device, a user may fully interact with the application 108 through the interface 106, while also having the contextually related links readily available therein.

In another embodiment, the apparatus 150 may further include the display of the domain information as it may relate to the application 108. Different applications may have different operating domains available to it, and therefore different links. Thus, the controller 172 may provide application data 174 to the domain selector 158. The selector 158, with this data may access the domain data database 160 to retrieve appropriate operating domain links. The selector 158 provides these links 176 to the interface 106 to be included in the display data 172. The inclusion of these operating domains is visible in the screen shot 130 of FIG. 3 as display element 138.

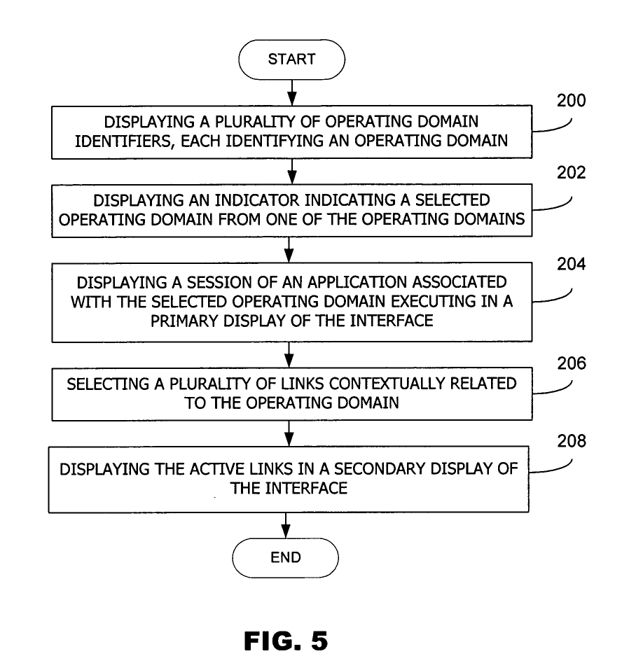

FIG. 5 provides a flow chart of the steps of one embodiment of a user interface display method. In this embodiment, the first step, step 200, is displaying a plurality of operating domain identifiers, each identifying an operating domain. As viewable in the screen shot 130 of FIG. 3, the interface includes the operating domain identifiers 138. The next step, step 202, is displaying an indicator indicating a selected operating domain from one of the operating domains. In the screen shot 130 of FIG. 3, the display 140 indicates that the selected operating domain is Sales Orders.

The next step, step 204, is displaying a session of an application associated with the selected operating domain executing in a primary display. Referring again to the screen shot 130, the primary display 132 illustrates the execution of an application relating to the selected operating domain. Through the interface, the user may perform the operating tasks to fully utilize the application.

The next step, step 206, is selecting a plurality of links contextually related to the operating domain. The next step, step 208, is thereupon displaying the links in a secondary display of the interface. In the screen shot 130 of FIG. 3, the links 136 are in the secondary display 134 and include a description of the corresponding underlying functionality. In the interface, selecting the link launches an activity that will provide the underlying functionality. Thereupon, in this embodiment, the method is complete.

The interface 106 provides a multi-display presentation for interaction with a requested application. Consistent with usage of that application, the interface allows for designated operating domains to be displayed. Additionally, in the interface is a secondary display including the readily accessible contextually related links. These links relate to activities directly associated with the application and/or the operating domain. Thus, the interface provides a central location for readily accessing links to better facilitate usage of data within the applications accessible through the interface. For example, a batch process operation associated with an operating domain may include number of defined steps or operations. These operations may be provided as links in the secondary display, providing user not only a guideline or rubric for performing a task, but also making the various steps quickly and readily accessible, thereby improving user efficiency through the interface.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A user interface display method comprising:
displaying a plurality of operating domain identifiers, each identifying an operating domain;
displaying an indicator indicating a selected operating domain from one of the operating domains;
displaying an session of an application associated with the selected operating domain executing in a primary display of the interface;
selecting a plurality of links contextually related to the operating domain; and
displaying the links in a secondary display of the interface.

2. The method of claim 1 wherein the link includes a description of a corresponding underlying functionality.

3. The method of claim 2 further comprising:
upon selection of one of the links, launching an activity providing the underlying functionality.

4. The method of claim 1 further comprising:
receiving an element selection of at least one element in the session;
receiving a selection of one of the links; and
launching an activity associated with the link based on the element selection in the session.

5. The method of claim 1 further comprising:
displaying a tab display for the session;
upon selection of one of the links, generating a tab display for an activity session based on the selected link; and
displaying the tab display for the activity session based on the link.

6. A user interface comprising:
a plurality of operating domain identifiers, each identifying an operating domain;
an indicator indicating a selected operating domain from one of the operating domains;
a primary display having an session of an application associated with the selected operating domain executing therein; and
a second display having a plurality of links, each of the links being contextually related to the selected operating domain.

7. The user interface of claim 6 wherein each of the links includes a description of a corresponding underlying functionality, such that the selection of one of the links launches an activity providing the underlying functionality.

8. The method of claim 7 further comprising:
a first tab display for the session; and
a second tab display for the activity launched by the selection of the link.

9. An apparatus providing a user interface display comprising:
an interface device;
a controller coupled to an application processing device operative to provide primary display data of an application executing on the application processing device to the interface;
an link selector coupled to the controller and receiving domain selection data which indicates an operating domain associated with the application
an link database having a plurality of links stored therein such that the link selector retrieves a plurality of links contextually related to the selected operating domain and provides the links to the interface; and
the interface device operative to generate display data including a primary display having the application executing therein and a secondary display including the contextually related links.

10. The apparatus of claim 9 further comprising:
a domain selector coupled to the controller and receiving domain selection data, where the domain selection data indicates an operating domain;
a domain database having operating domain identifiers stored therein; and
the domain selector operative to retrieve a plurality of the domain identifiers and provide the plurality of domain identifiers to the interface device such that display data includes the display of plurality of domain identifiers.

11. The apparatus of claim 10 further comprising:
a display device coupled to the interface device, operative to receive the display data and provide a visual display thereon.

12. A user interface device comprising:
a memory device storing executable instructions therein; and
a processing device, in response to the executable instructions, operative to:
display a plurality of operating domain identifiers, each identifying an operating domain;
display an indicator indicating a selected operating domain from one of the operating domains;
display a session of an application associated with the selected operating domain executing in a primary display of the interface;
select a plurality of links contextually related to the operating domain; and
display the links in a secondary display of the interface.

13. The user interface of claim 12 wherein the link includes a description of a corresponding underlying functionality.

14. The user interface of claim 13, wherein the processing device is further operative to:
upon selection of one of the links, launch an activity providing the underlying functionality.

15. The user interface of claim 12, wherein the processing device is further operative to:
receive an element selection of at least one element in the session;
receive a selection of one of the links; and
launch an activity associated with the link based on the element selection in the session.

16. The user interface of claim 12, wherein the processing device is further operative to:
display a tab display for the session;
upon selection of one of the links, generate a tab display for an activity session based on the selected link; and
display the tab display for the activity session based on the link.
